(19) United States
(12) Patent Application Publication
(10) Pub. No.: US 2026/0021588 A1
(43) Pub. Date: Jan. 22, 2026

(54) USER-ROBOT INTERACTION SYSTEM

(71) Applicant: CLEMENTONI S.P.A., RECANATI (MC) (IT)

(72) Inventors: Michele SASSO, CASTELFIDARDO (AN) (IT); Alessia GIORDANI, OSIMO (AN) (IT)

(21) Appl. No.: 19/241,641

(22) Filed: Jun. 18, 2025

(30) Foreign Application Priority Data
Jul. 17, 2024 (IT) 102024000016549

(51) Int. Cl. B25J 9/16; B25J 13/00

(52) U.S. Cl. CPC B25J 9/1697; B25J 13/006

(57) ABSTRACT

User-robot interaction system including a robot, a wireless communication module, an image detector, and a processing unit configured to implement a user pose algorithm configured to receive the images from the image detector, identify keypoints in the image and calculate a three-dimensional position of the keypoints, and a robot pose algorithm configured to receive the three-dimensional position of the keypoints calculated by the user pose algorithm and process control signals suitable for driving the actuators of the robot in order to move the robot in accordance with the user's movements.

### CROSS-REFERENCE TO RELATED APPLICATIONS

Not applicable.

### FIELD OF THE INVENTION

The present invention relates to a user-robot interaction system. The term “robot” refers to an element equipped with actuators that control the movements of the robot or parts of the robot. Such a system is particularly suitable for being used in a game in which the robot makes movements similar or compatible with those performed by the user, who may be a child. Furthermore, such a system is particularly suitable for being used by disabled users with motor and cognitive difficulties.

### BACKGROUND OF THE INVENTION

In the field of robotics, user-robot interaction systems are known, which are configured to have the robot perform certain movements based on the user's movements. However, such systems are particularly complex and therefore they are exclusively applied in the specific field of industrial automation.

Examples of robots that interact with a user are described in the following documents:
FILIATRAULT SYLVAIN ET AL: “Human arm motion imitation by a humanoid robot.” 2014 IEEE INTERNATIONAL SYMPOSIUM ON ROBOTIC AND SENSORS ENVIRONMENTS (ROSE) PROCEEDINGS. IEEE, Oct. 16, 2014
FERNANDO ZUHER ET AL: “Recognition of Human Motions for Imitation and Control of a Humanoid Robot”, ROBOTICS SYMPOSIUM AND LATIN AMERICAN ROBOTICS SYMPOSIUM (ABR-LARS). 2012 BRAZILIAN, IEEE, Oct. 16, 2012
ELBASIONY REDA ET AL: “Humanoids skill learning based on real-time human motion imitation using Kinect”. INTELLIGENT SERVICE ROBOTICS. SPRINGER BERLIN HEIDELBERG. vol. 11, no. 2. Feb. 15, 2018
US2020030971A1 discloses a robotic manipulation system for executing a domain-specific application in an instrumented environment with electronic manipulation mini libraries.

### SUMMARY OF THE INVENTION

The purpose of the present invention is to eliminate the drawbacks of the prior art by providing a user-robot interaction system that is suitable for being used as a game for a child or as a learning system for a disabled person with motor and cognitive difficulties.

Another purpose is to provide such a user-robot interaction system that is reliable, accurate, and inexpensive.

These purposes are achieved in accordance with the invention with the characteristics of the attached independent claim or claims.

Advantageous embodiments of the invention appear from the dependent claims.

### BRIEF DESCRIPTION OF DRAWINGS

Additional features of the invention will become clearer from the following detailed description, referring to a purely exemplary and therefore non-limiting embodiment illustrated in the accompanying drawings.

FIG. 1 is a block diagram schematically illustrating the user-robot interaction system according to the invention.

FIG. 2 is a diagrammatic view illustrating the robot actuators.

FIG. 3 is a block diagram illustrating the user pose algorithm in greater detail.

FIG. 4 is a diagrammatic view illustrating a shape obtained from an image of the user and the keypoints identified on said shape.

FIG. 5 is a block diagram illustrating the robot pose algorithm in greater detail.

FIG. 6 is a block diagram illustrating the start and end position detection algorithm in greater detail.

### DETAILED DESCRIPTION OF THE INVENTION

With the aid of the figures, the user-robot interaction system according to the invention, which is comprehensively indicated with reference numeral 100, is described.

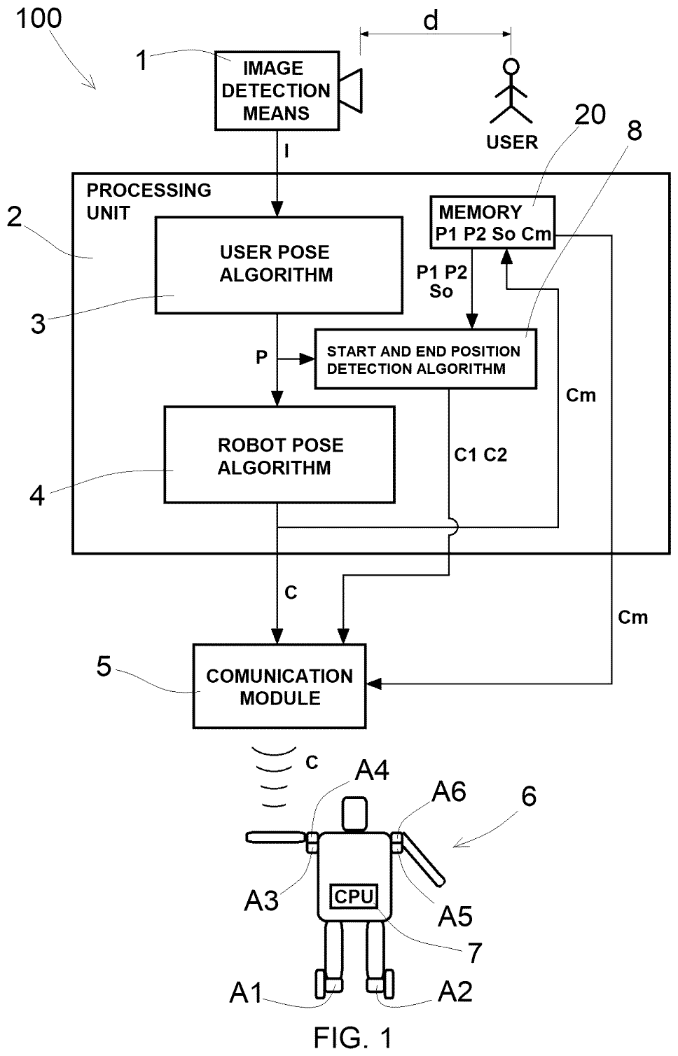

With reference to FIG. 1, the system (100) comprises a robot (6) that has at least one actuator (A1, . . . A6) that moves a part of the robot.

The system (100) comprises image detection means (1) suitable for capturing a moving user to provide a digital image (I) of the user in various positions assumed by the user while moving.

The image detection means (1) may comprise a video camera or an RGB camera with depth sensors and motion acquisition devices.

The image detection means (1) are connected to a processing unit (2) to process the image (I) captured by the image detection means (1).

The processing unit (2) is configured to implement two algorithms, namely a user pose algorithm (3) and a robot pose algorithm (4).

Based on the image (I) from the image detection means (1), the user pose algorithm (3) identifies keypoints in the image and calculates a position (P) of said keypoints.

Based on the position (P) of the keypoints calculated by the user pose algorithm (3), the robot pose algorithm (4), processes control signals (C) suitable for operating the actuators (A1, . . . A6) of the robot to move the robot.

The system (100) comprises a wireless communication module (5) connected to the processing unit (2) to wirelessly control the actuators (A1, . . . A6) of the robot.

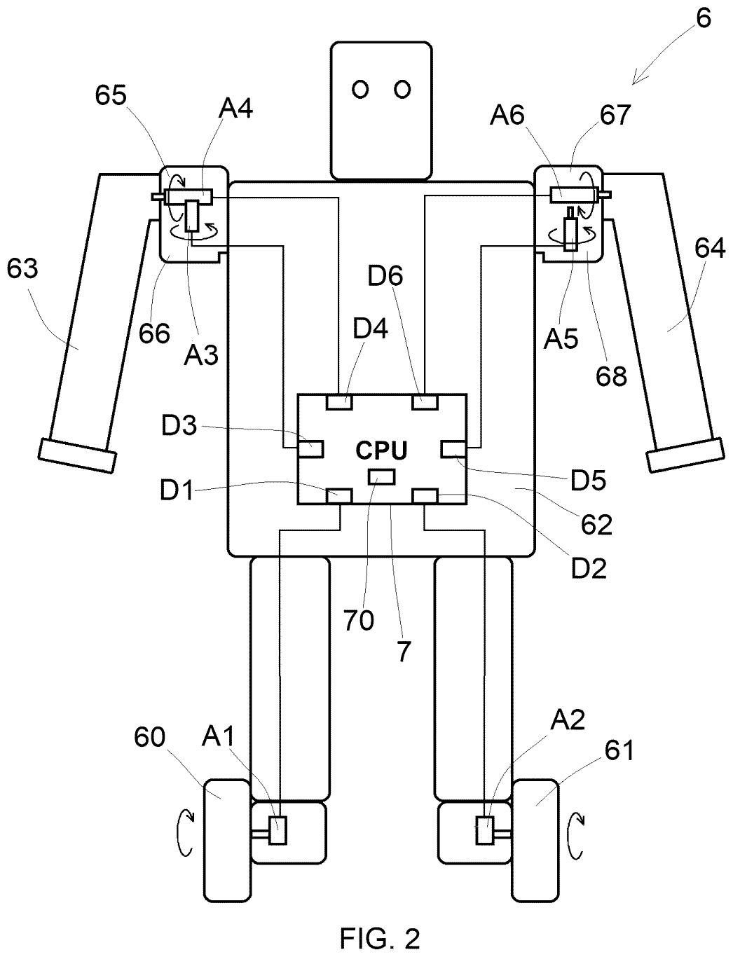

With reference to FIG. 2, the robot (6) is supported on two wheels (60, 61). In such a case, the robot comprises a first actuator (A1) and a second actuator (A2) consisting of electric motors that rotate the two wheels (60, 61) respectively. In this way, the robot (6) can rotate and move in any direction.

The robot (6) has a body (62) and two arms (63, 64) that are movable relative to the body (62). The right arm (63) is moved by two actuators (A3, A4) consisting of electric motors with axes of rotation orthogonal to each other. The left arm (64) is moved by two actuators (A5, A6) consisting of electric motors with axes of rotation orthogonal to each other.

The right arm (63) is mounted so as to rotate with respect to a first joint (65) around a horizontal axis. The first joint (65) is mounted so as to rotate around a vertical axis with respect to a first support (66) integral with the body (62). A third actuator (A3) rotates the first joint (65). A fourth actuator (A4) rotates the right arm (63).

The left arm (64) is mounted so as to rotate with respect to a second joint (67) around a horizontal axis. The second joint (67) is mounted so as to rotate around a vertical axis with respect to a second support (68) integral with the body (62). A fifth actuator (A5) rotates the second joint (67). A sixth actuator (A6) rotates the left arm (64).

The actuation of the third and fifth actuator (A3, A5) moves the arms (63, 64) horizontally to the right or to the left. The activation of the fourth and sixth actuator (A4, A6) lowers or raises the arms (63, 64).

The robot (6) comprises a control unit (7) wherein drivers (D1, . . . D6) are installed to control the actuators (A1, A6) of the robot, respectively.

The control unit (7) is connected to a wireless receiver (70) connected to the communication module (5) to receive control signals (C) for actuating the actuators (A1, . . . A6). By way of example, the communication module (5) and the wireless receiver (70) may be of Bluetooth, Wi-Fi, or similar type. Preferably, the communication module (5) and the wireless receiver (70) are of Bluetooth Low Energy (BLE) type.

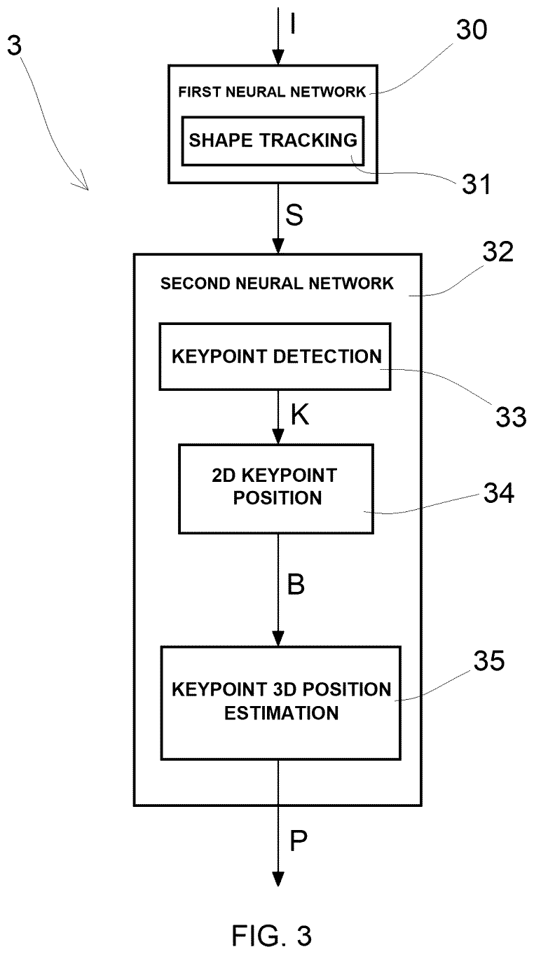

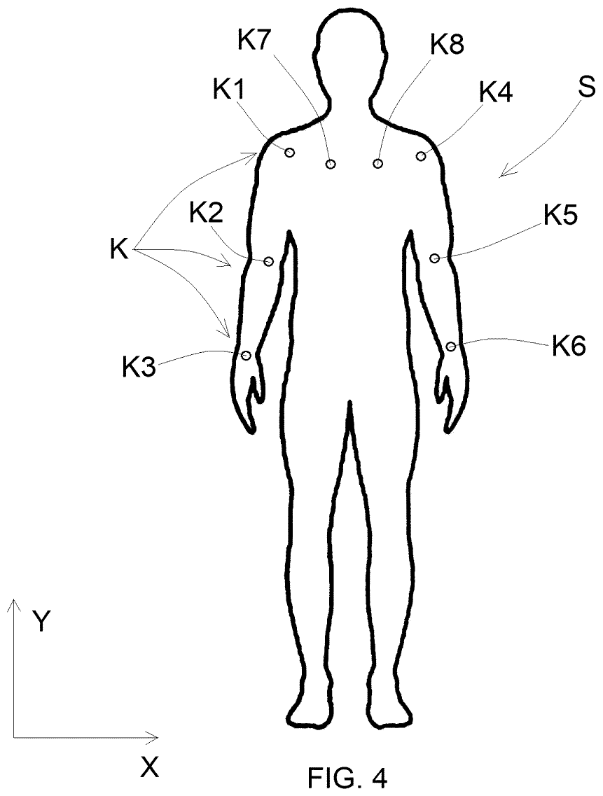

With reference to FIG. 3, the user pose algorithm (3) comprises a first neural network (30) wherein a shape tracking algorithm (31) is implemented. The shape tracking algorithm (31) receives the image (I) from the image detection means (1), evaluates whether a user has been captured in that image and, if a user has been captured, traces a shape(S) of the user, as shown in FIG. 4. In such a case, the shape(S) of the user is two-dimensional, i.e. on an X-Y plane.

The shape (S) of the user is sent to a second neural network (32) wherein a keypoint detection algorithm (33) is implemented and configured to detect certain keypoints (K) from the shape(S) of the user.

With reference to FIG. 4, the keypoints (K) can be identified at specific points of the shape(S) that allow a movement of the shape or parts of the shape to be identified. For illustrative purposes, in order to identify a movement of the right arm, three keypoints (K1, K2, K3) are used, respectively at the shoulder, elbow, and wrist of the right arm.

In order to identify a movement of the left arm, three keypoints (K4, K5, K6) are used, respectively at the shoulder, elbow, and wrist of the left arm.

In order to identify a rotation of the trunk, two keypoints (K7, K8) are used in two points on the trunk.

Although FIG. 4 illustrates an example of keypoint detection in a shape(S) of a normal standing person, the invention obviously extends to the possibility of detecting keypoints in a shape of disabled persons, such as persons in wheelchairs or persons with missing limbs or limb mobility disability.

In the second neural network (32) a keypoint position detection algorithm (34) is installed to detect a two-dimensional position (B) of the various keypoints (K) identified by the keypoint detection algorithm (33). In such a case, the position of the keypoints (K) is a two-dimensional position (B) on an X-Y plane. Otherwise said, each keypoint (K) is associated with a two-dimensional position (B) in Cartesian coordinates on an X-Y plane.

The two-dimensional position (B) of the keypoints (K) is sent to a 3D position estimation algorithm (35) configured to estimate a three-dimensional position (P) of each keypoint (K). In such a case, the position of the keypoints (K) is a three-dimensional position (P) in the space, according to a system of Cartesian axes X-Y-Z. Otherwise said, each keypoint (K) is associated with a three-dimensional position (P) in Cartesian coordinates in the X-Y-Z space.

The 3D position estimation algorithm (35) is part of the second neural network (32).

So the 3D position estimation algorithm (35) outputs the three-dimensional position (P) of each keypoint (K).

The 3D position estimation algorithm (35) is well known and is commercially available. For example, the 3D position estimation algorithm (35) uses the 3D model known as GHUM (Generative 3D Human Shape and Articulated Pose Model) to estimate the 3D pose of the person from the (two-dimensional) image. The 3D position is local with respect to the person's center of mass, and therefore no information about the user's distance from the image detection means (1) is required.

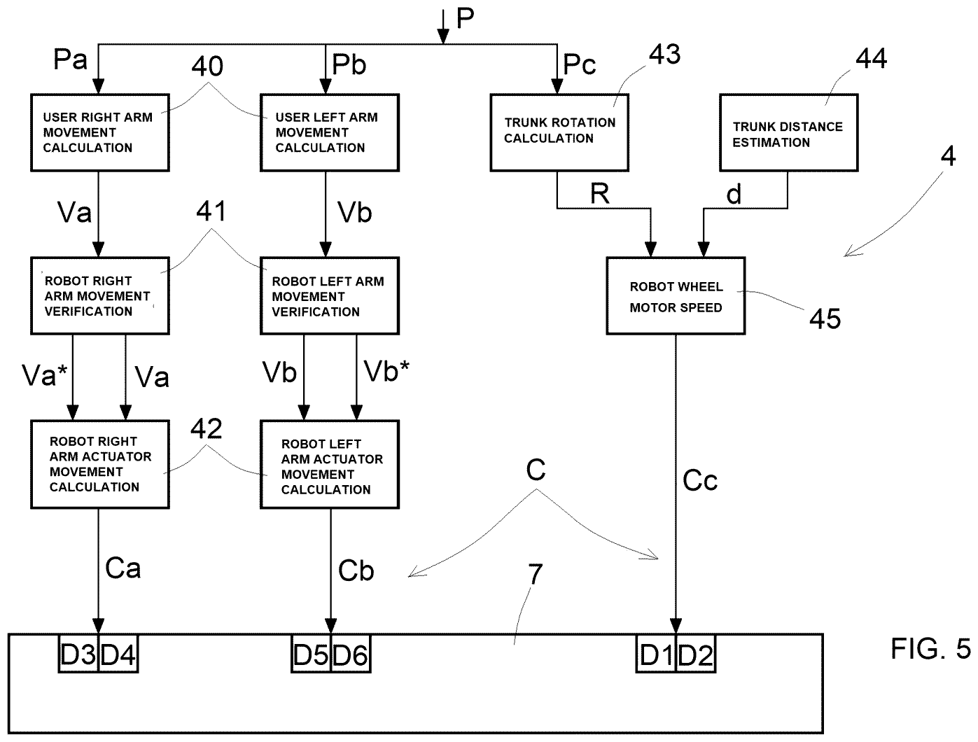

With reference to FIG. 5, the three-dimensional positions (P) of the keypoints (K) estimated by the 3D estimation algorithm (35) include first three-dimensional positions (Pa) of the keypoints (K1, K2, K3) for the movement of the right arm, second three-dimensional positions (Pb) of the keypoints (K4, K5, K6) for the movement of the left arm, and third three-dimensional positions (Pc) of the keypoints (K7, K8) relative to the rotation of the trunk.

The first three-dimensional positions (Pa) and the second three-dimensional positions (Pb) are treated differently from the third three-dimensional positions (Pc).

The robot pose algorithm (4) comprises a user arm movement calculation algorithm (40) that receives the first three-dimensional positions (Pa) relative to the keypoints of the user's right arm and the second three-dimensional positions (Pb) relative to the user's left arm.

Based on said first and second three-dimensional positions (Pa, Pb), the user arm movement calculation algorithm (40) constructs a first arm movement vector (Va) representing the direction of movement of the user's right arm, and a second arm movement vector (Vb) representing the direction of movement of the user's left arm.

The robot pose algorithm (4) comprises a robot arm movement verification algorithm (41) in which end-of-travel values are stored, defining a range of movement for each arm (63, 64) (FIG. 2) of the robot, i.e., a range in which each arm of the robot can move without hitting other parts of the robot.

The robot arm movement verification algorithm (41) receives the first arm movement vector (Va) representing the direction of movement of the user's right arm, and the second arm movement vector (Vb) representing the direction of movement of the user's left arm as input and verifies whether the arm movement vectors (Va, Vb) are comprised within the respective ranges of movement of the respective robot arm.

If one of the arm movement vectors (Va, Vb) is not comprised within the range of movement of the respective robot arm, the robot arm movement verification algorithm (41) corrects the arm movement vector (Va, Vb) and approximates it with a limited vector (Va*; Vb*) that is comprised within the range of movement of the robot arm.

The arm movement vectors (Va, Vb) or the limited vectors (Va*, Vb*) are sent to a robot arm actuator movement calculation algorithm (42) which calculates a control signal (Ca, Cb) to actuate the respective robot arm. A first control signal (Ca) contains information on the movement to be imparted to the actuators (A3, A4) of the right arm to control the desired movement of the robot's right arm. A second control signal (Cb) contains information on the movement to be imparted to the actuators (A5, A6) of the left arm to control the desired movement of the robot's left arm.

With reference to FIG. 2, the first control signal (Ca) is sent to the third and fourth driver (D4, D5) which activate the third and fourth actuator (A3, A4) to move the right arm (63) of the robot. The second control signal (Cb) is sent to the fifth and sixth driver (D5, D6), which activate the fifth and sixth actuator (A5, A6) to move the left arm (64) of the robot.

Going back to FIG. 5, the robot pose algorithm (4) comprises a trunk rotation calculation algorithm (43) that receives the third three-dimensional positions (Pc) relative to the keypoints (K7, K8) of the user's trunk.

Based on the third three-dimensional positions (Pc), the trunk rotation calculation algorithm (43) calculates a rotation (R) executed by the user's trunk; starting from an initial position of the user's trunk, the rotation (R) takes into account how much the user's trunk has rotated to the right or to the left. Such a rotation (R) is also indicative of the direction in which the user intends to walk.

The robot pose algorithm (4) also comprises a trunk distance estimation algorithm (44) that is capable of estimating a distance (d) (FIG. 1) between the user's trunk and the image detection means (1) that must obviously be fixed. If the image detection means (1) comprise depth sensors, said distance (d) can be calculated accurately as distance between a target and a camera lens.

The robot pose algorithm (4) comprises a robot wheel motor speed calculation algorithm (45) configured to calculate a speed of the motors of the two actuators (A1, A2) of the wheels (60, 61) of the robot and output a third control signal (Cc) indicating the speed at which to drive the motors of the first and second actuators (A1, A2).

The robot wheel motor speed calculation algorithm (45) receives the rotation (R) of the user's trunk and the distance (d) of the user's trunk from the vision sensors as input.

If the rotation (R) indicates that the trunk has rotated to the right or left from an initial position, the motors of the actuators (A1, A2) of the wheels (60, 61) of the robot are rotated at different speeds so as to cause the robot (6) to rotate to the right or left.

If the distance (d) varies with respect to an initial distance, it means that the user is walking in a direction. In such a case, the motors of the actuators (A1, A2) of the wheels (60, 61) of the robot are rotated at the same speed to move the robot (6) forward in the same direction as the user.

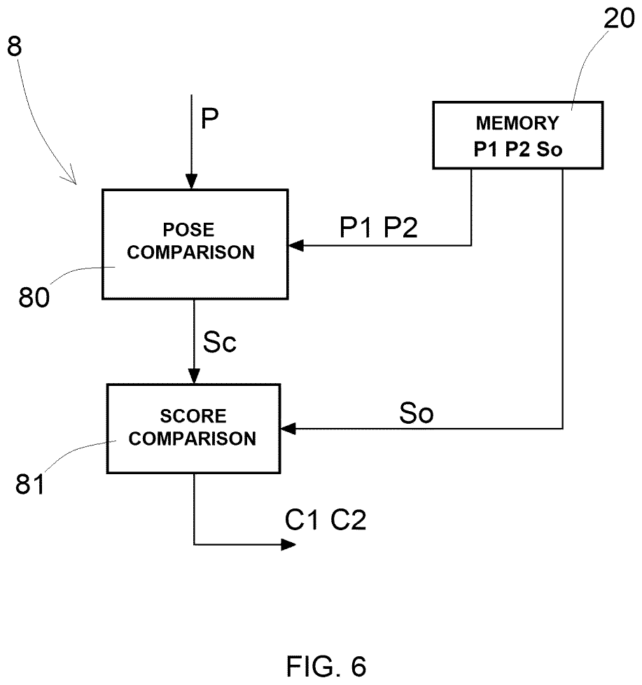

With reference to FIGS. 1 and 6, the processing unit (2) has a memory (20) in which a start position (P1) indicative of a position of the user for starting the movement of the robot (6), and an end position (P2) indicative of a position of the user for ending the movement of the robot (6) are stored. By way of example, the start position (P1) may be the raising of the user's right arm and the end position (P2) may be a T-pose of the user.

The processing unit (2) implements a start and end position detection algorithm (8) that provides first comparison means (80) for comparing the three-dimensional position (P) of the keypoints obtained from the image (I) captured by the visual sensors with the start and end positions (P1, P2) stored in the memory.

Since the start and end positions (P1, P2) depend on the positions of the user's arms, in this case, the comparison will be made on the three-dimensional position of the keypoints (K1, K2, K3) of the right arm and on the three-dimensional position of the keypoints (K4, K5, K6) of the left arm. Following this comparison, a score (Sc) is output relative to the similarity of the three-dimensional position (P) of the arm keypoints with the start and end positions (P1, P2) that have been preset.

A threshold score (So) is also stored in the memory (20) and acts as a discriminator.

The start and end position detection algorithm (8) comprises second comparison means (81) that compare the score (Sc) with the threshold score (So). If the score (Sc) obtained is greater than the threshold score (So), in the case of similarity of the three-dimensional position (P) with the start position (P1), a start control signal (C1) is sent to the control unit (7) of the robot which enables the start of the movement of the robot (6).

If the score (Sc) is greater than the threshold score (So), in the case of similarity of the three-dimensional position (P) with the end position (P2), an end control signal (C2) is sent to the control unit (7) of the robot, which enables the end of the movement of the robot (6).

The memory (20) of the processing unit (2) can also be used to store a sequence of user movements. The sequence of user movements is stored as a sequence of control signals (CM) to be sent to the control unit (7) of the robot to make the robot perform a sequence of movements. In this way, the user can cause the robot (6) to execute the sequence of movements that has been stored in the control unit.

1. User-robot interaction system comprising:
a robot comprising a control unit and actuators controlled by said control unit;
a wireless communication module configured to send control signals to said control unit of the robot in wireless mode in order to drive said actuators of the robot;
image detection means configured to detect images of a user; and
a processing unit configured to receive said images detected by the image detection means and accordingly generate said control signals that are sent to said control unit of the robot via the communication module;
wherein the processing unit is configured to implement:
a user pose algorithm configured to receive the images from the image detection means, identify keypoints in the image and calculate a three-dimensional position of said keypoints; and
a robot pose algorithm configured to receive the three-dimensional position of the keypoints calculated by the user pose algorithm and process control signals suitable for driving the actuators of the robot in order to move the robot in accordance with the user's movements;
wherein said user pose algorithm comprises:
a first neural network configured to implement a shape tracking algorithm configured to receive the image from the image detection means and track a two-dimensional shape of the user; and
a second neural network configured to receive said shape;
said second neural network being configured to implement:
a keypoint detection algorithm configured to receive said shape and detect certain keypoints from the shape of the user;
a keypoint position detection algorithm configured to detect a two-dimensional position of the various keypoints detected by the keypoint detection algorithm; and
a 3D position estimation algorithm configured to receive the two-dimensional position of the keypoints and estimate a three-dimensional position of each keypoint (K).

2. The system of claim 1, wherein:
said keypoints comprise keypoints suitable for identifying a movement of the user's right arm, and said three-dimensional positions comprise first three-dimensional positions relative to the keypoints of the user's right arm;
said actuators of the robot comprise actuators suitable for enabling a movement of a right arm of the robot; and
said robot pose algorithm comprises:
a user arm movement calculation algorithm that receives the first three-dimensional positions relative to the keypoints of the right arm of the user and constructs a first arm movement vector representing the movement direction of the user's right arm; and
a robot arm actuator movement calculation algorithm configured to receive said first arm movement vector and calculate a first control signal to drive said actuators of the right arm of the robot.

3. The system of claim 2, wherein said robot pose algorithm comprises a robot arm movement verification algorithm wherein end-of-travel values are stored, which define a movement range of the right arm of the robot, said robot arm movement verification algorithm being configured to receive the first arm movement vector as input and verify whether said first arm movement vector is comprised in the movement range; in the case that the first arm movement vector is not comprised in the movement range, the robot arm movement verification algorithm corrects the first arm movement vector and approximates it with a limited vector comprised in the movement range of the arm of the robot; said limited vector being sent to said robot arm actuator movement calculation algorithm.

4. The system of claim 1, wherein:
said keypoints comprise keypoints suitable for identifying a movement of a left arm of the user, and said three-dimensional positions comprise second three-dimensional positions related to the keypoints of the user's left arm;
said robot actuators comprise actuators suitable for enabling a movement of a left arm of the robot; and
said robot pose algorithm comprising:
a user arm movement calculation algorithm that receives the second three-dimensional positions relative to the keypoints of the user's left arm and constructs a second arm movement vector representing the movement direction of the user's left arm; and
a robot arm actuator movement calculation algorithm configured to receive said second arm movement vector and calculate a second control signal to drive said actuators of the left arm of the robot.

5. The system of claim 4, wherein said robot pose algorithm comprises a robot arm movement verification algorithm in which end-of-travel values are stored, which define a movement range of the left arm of the robot; said robot arm movement verification algorithm being configured to receive the second arm movement vector as input and verify whether said second arm movement vector is comprised in the movement range; in the case that the second arm movement vector is not comprised in the movement range, the robot arm movement verification algorithm corrects the second arm movement vector and approximates it with a limited vector comprised in the movement range of the left arm of the robot; said limited vector being sent to said robot arm actuator movement calculation algorithm.

6. The system of claim 1, wherein:
said keypoints comprise keypoints suitable for identifying a rotation of the user's trunk;
and said three-dimensional positions comprise third three-dimensional positions of the keypoints relative to the rotation of the trunk;
said robot actuators comprise actuators suitable for enabling a rotation of a trunk of the robot; and
said robot pose algorithm comprises a trunk rotation calculation algorithm that receives the third three-dimensional positions relative to the keypoints of the user's trunk and calculates a rotation of the user's trunk.

7. The system of claim 6, wherein said actuators suitable for enabling a rotation of the robot's trunk are two electric motors that drive two wheels into rotation; and said robot pose algorithm comprises:
a trunk distance estimation algorithm suitable for estimating a distance between the user's trunk and the image detection means; such a distance can be calculated accurately in the case where the image detection means also comprise depth sensors, as distance between a target and a camera lens; and
a robot wheel motor speed calculation algorithm configured to calculate a speed of the motors of the two actuators of the wheels of the robot and output a third control signal indicative of the speed applied to the motors of the actuators of the wheels of the robot.

8. The system of claim 1, wherein said processing unit is configured to implement a start and end position detection algorithm, said start and end position detection algorithm comprising:
first comparison means configured to compare the three-dimensional position of the keypoints obtained from the image taken by the visual sensors with start and end positions stored in a memory and output a score relative to the similarity of the three-dimensional position of the keypoints with the start and end positions; and
second comparison means configured to compare the score with a threshold score stored in the memory, in such a way that, if the score is greater than the threshold score, in the case of similarity of the three-dimensional position with the start position, a start control signal is sent to the control unit of the robot to enable the start of the movement of the robot; if the score is greater than the threshold score, in the case of similarity of the three-dimensional position with the end position, an end control signal is sent to the control unit of the robot to enable the end of the movement of the robot.

9. The system of claim 1, further comprising a memory of the processing unit wherein a sequence of movements of the user is stored as sequence of control signals to be sent to the control unit of the robot to have the robot execute a sequence of movements.
